(19) United States
(12) Patent Application Publication
(10) Pub. No.: US 2019/0283514 A1
(43) Pub. Date: Sep. 19, 2019

(54) CONFIGURABLE TAIL FOR FLYING CAR

(71) Applicant: AEROMOBIL R&D, S.R.O., Bratislava (SK)

(72) Inventors: Douglas MacAndrew, Bystrica (SK); Simon Rooms, Bratislava (SK); Martin Gren, Ostrava (SK)

(73) Assignee: AEROMOBIL R&D, S.R.O., Bratislava (SK)

(21) Appl. No.: 16/345,164

(22) PCT Filed: Oct. 23, 2017
(86) PCT No.: PCT/EP2017/077017

§ 371 Date: Apr. 25, 2019

(30) Foreign Application Priority Data
Oct. 25, 2016 (EP) 16195570.3

(51) Int. Cl. B60F 5/02; B64C 37/00; B64C 3/56

(52) U.S. Cl. CPC B60F 5/02; B64C 3/56; B64C 37/00

(57) ABSTRACT

A vehicle configurable for air or road use (a flying car), comprising a body having road wheels for supporting the body when configured for road use; wings connected to the body and deployable for air use; and a tail section at the rear of the body, comprising at least one horizontal tailplane; wherein the at least one horizontal tailplane includes a planar rearmost edge section that is pivotable about an axis transverse to the longitudinal axis of the vehicle between a first position in which the plane of the rearmost edge section is substantially horizontal, and a second position in which the plane of the rearmost edge section is substantially vertical, and can function as a rear bumper in road use configuration.

### FIELD OF THE INVENTION

This invention relates to vehicles that are configurable for air use (flying) and road use (driving). Such vehicles are commonly known as flying cars or roadable aircraft (hereafter “flying cars”). In particular, the invention relates to a configurable tail unit that is capable of functioning as a rear bumper in road use.

### BACKGROUND

There have been a number of previous proposals for flying car designs, i.e. vehicles that can be fully complaint with legal and practical requirements for both road and flight use. Examples include the Terrafugia Transition (WO 2007/114877), the Carplane (http://carplane.de/), the AeroMobil (WO 2013/032409), and the Moller Skycar (http://moller.com/). The first three of these all include a propeller as the means of providing thrust in the flight configuration, in particular in a pusher arrangement.

In order to comply with regulatory requirements for use on public roads, it is common for vehicles to have to be provided with a rear bumper or fender (hereinafter “bumper”). Rear bumpers are intended to provide protection to both the vehicle and its occupants in the event of a rear collision, and limit damage or injury to other vehicles and pedestrians, such as during reversing or parking. Typical regulations specify the height of the bumper above the ground (usually a minimum height), the dimensions of the bumper, and its impact or deformability characteristics.

One problem with such requirements is that they can lead to increased drag or other reduced aerodynamic performance when the flying car is configured for flight. This invention is an attempt to reconcile the need for certain minimum physical dimensions and performance as a bumper for road use with the desire for reduced drag in flight.

### SUMMARY

A first aspect of the invention provides a vehicle configurable for air or road use (a flying car), comprising a body having road wheels for supporting the body when configured for road use; wings connected to the body and deployable for air use; and a tail section at the rear of the body, comprising at least one horizontal tailplane; wherein the at least one horizontal tailplane includes a planar rearmost edge section that is pivotable about an axis transverse to the longitudinal axis of the vehicle between a first position in which the plane of the rearmost edge section is substantially horizontal, and a second position in which the plane of the rearmost edge section is substantially vertical.

The tailplane can comprise the rearmost edge section and a fixed horizontal section, wherein in the first position, the rearmost edge section is positioned adjacent the fixed horizontal section so as to lie in substantially the same horizontal plane, and in the second position is spaced rearwardly from the fixed horizontal section.

The axis about which the rearmost edge section pivots can be spaced from the plane of the horizontal tailplane.

In one embodiment, the vehicle further comprises at least one vertical fin, a pivot point on the transverse axis being defined on the at least one fin, and a hinge connecting the rearmost edge section to the pivot point on the at least one fin. The vehicle can comprise a pair of vertical fins, the horizontal tailplane extending between the fins, and a hinge being provided at each end of the rearmost edge section and connected to the pivot point on a respective fin. In this case, a road wheel can be located at a lower region of each of the pair of vertical fins. The vehicle can also comprise a central fin and a hinge connecting the rearmost edge section to the pivot point on the central fin.

A propeller can be mounted on the tail section. In this case, when in the second position, the substantially vertical plane of the rearmost edge section can be behind the propeller. The horizontal tailplane can be located below the mounting point of the propeller.

Where the vehicle comprises a biplane tailplane, the at least one horizontal tailplane can be a lower tailplane.

The rearmost edge section can be configured to act as a rear bumper when in the second position when the vehicle is configured for road use.

Further variations can be made within the scope of the invention.

### DRAWINGS

FIG. 1 shows a front perspective view of a flying car in a flight configuration;

FIG. 2 shows a front perspective view of a flying car in a road use configuration;

FIG. 3 shows the tail section of the flying car of FIG. 1; and

FIG. 4 shows the tail section of the flying car of FIG. 2.

### DETAILED DESCRIPTION

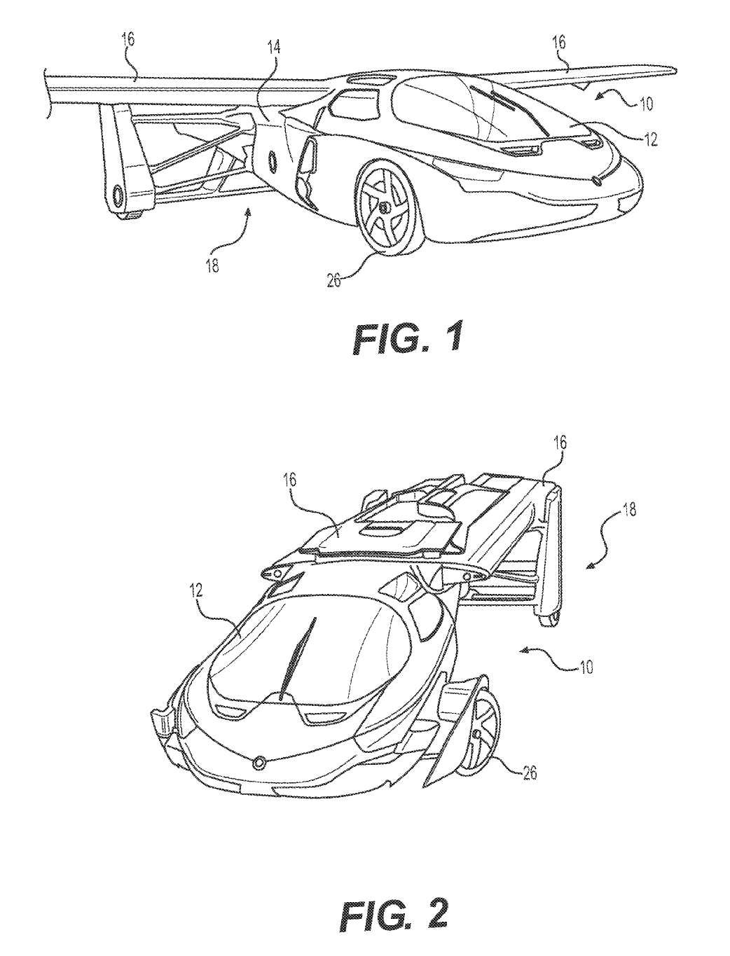

Referring to FIGS. 1 and 2, an aircraft comprising a convertible vehicle (a flying car) is shown, in a flight configuration (FIG. 1) and a road use configuration (FIG. 2). The flying car comprises a body structure 10 providing a crew compartment 12 and housing a motor (not shown) and propeller shaft (not shown) that extends from the motor to the rear 14 of the body structure 10, where the propeller is mounted as is described below. Wings 16 for providing lift and control (via ailerons, not shown) are mounted at the top of the body 10 immediately behind the crew compartment 12. The wings 16 can be moved between an extended position for flight use (FIG. 1), and a folded position for road use (FIG. 2). In the folded position, the wings lie along the top of the body 10, the long axis of the wings lying substantially parallel to the long axis of the body 10. The folding mechanism is substantially as described in WO 2013/03240.

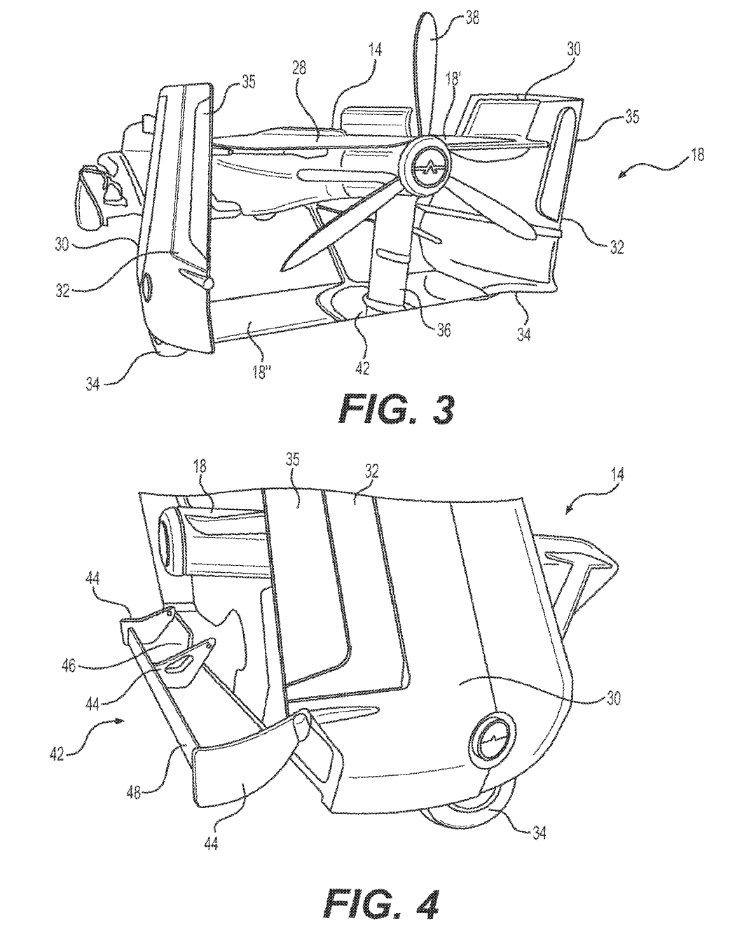

A tail structure 18 is located at the rear of the body 14 as is described in further detail with reference to FIGS. 3 and 4.

Front wheels 26 are mounted on the body structure 10. The front wheels are both steerable and driven. In addition, the front wheels 26 can be moved between a retracted position (FIG. 1) in which they are positioned close to the body to reduce drag in flight, and an open position (FIG. 2) in which they are positioned for improved traction and control for road use.

Referring now to FIG. 3, the tail structure 18 comprises a biplane tailplane 18′, 18″, the upper tailplane 18′ being connected to the rear part of the body 14. Elevators 28 are provided on the upper plane 18′ only. A pair of fins 30 are provided, each having a rudder 32, the tailplanes 18′, 18″ extending between the fins 30. Rear road wheels 34 are mounted at the lower part of each fin 30, and rear road light units 35 are provided in the training edge of each fin 30. A central fin 36 extends downwardly from the rear body part 14 to the lower tailplane 18″. A propeller 38 is mounted on the rear body 14 immediate behind the trailing edge of the upper tailplane 18′.

The lower tailplane 18″ has a two-part construction, comprising a fixed horizontal section 40, and a movable rearmost edge section 42. As shown in FIG. 3, the rearmost edge section 42 is positioned adjacent to the fixed section 40 and lies in substantially the same horizontal plane. In this configuration, the lower tailplane 18″ presents relatively low drag and can function to provide aerodynamic pitch stability.

Referring now to FIG. 4, the rearmost edge section 42 is connected to pivot points on the fins 32, 36 by hinged support arms 44, which are hinged to the fins 32, 36 above the plane of the lower tailplane 18″. An actuator 46 is connected between the central fin 36 and the associated support arm 44.

Operation of the actuator 46 causes the rearmost edge section 42 to pivot up around the pivot points until it lies in a substantially vertical plane as shown in FIG. 4. The lower surface 48 of the rearmost edge section is now presented to the rear and can act as a bumper when the vehicle is configured for road use. The length of the arms 44 is such that the lower surface is positioned behind the propeller, i.e. is the rearmost extent of the vehicle, and is at a suitable height to meet road use regulatory requirements. The process is reversed to return the vehicle to flight configuration.

Various changes can be made while remaining within the scope of the invention. For example, the exact configuration of fins and tailplanes can vary from the biplane unit described above. Other changes can also be made.

1. A vehicle configurable for air or road use, comprising:
a body having road wheels for supporting the body when configured for road use;
wings connected to the body and deployable for air use; and
a tail section at the rear of the body, comprising at least one horizontal tailplane;
wherein
the at least one horizontal tailplane includes a planar rearmost edge section that is pivotable about an axis transverse to the longitudinal axis of the vehicle between a first position in which the plane of the rearmost edge section is substantially horizontal, and a second position in which the plane of the rearmost edge section is substantially vertical.

2. The vehicle of claim 1, wherein the tailplane comprises the rearmost edge section and a fixed horizontal section, wherein in the first position, the rearmost edge section is positioned adjacent the fixed horizontal section so as to lie in substantially the same horizontal plane, and in the second position is spaced rearwardly from the fixed horizontal section.

3. The vehicle of claim 1, wherein the axis about which the rearmost edge section pivots is spaced from the plane of the horizontal tailplane.

4. The vehicle of claim 1, further comprising at least one vertical fin, a pivot point on the transverse axis being defined on the at least one fin, and a hinge connecting the rearmost edge section to the pivot point on the at least one fin.

5. The vehicle of claim 4, further comprising a pair of vertical fins, the horizontal tailplane extending between the fins, and a hinge being provided at each end of the rearmost edge section and connected to the pivot point on a respective fin.

6. The vehicle of claim 5, wherein a road wheel is located at a lower region of each of the pair of vertical fins.

7. The vehicle of claim 4, comprising a central fin and a hinge connecting the rearmost edge section to the pivot point on the central fin.

8. The vehicle of claim 1, further comprising a propeller mounted on the tail section.

9. The vehicle of claim 8, wherein, when in the second position, the substantially vertical plane of the rearmost edge section is behind the propeller.

10. The vehicle of claim 9, wherein the horizontal tailplane is located below the mounting point of the propeller.

11. The vehicle of claim 1, comprising a pair of horizontal tail surfaces a first horizontal tail surface being spaced above a second horizontal tail surface in a biplane arrangement, the at least one horizontal tailplane being the second horizontal tail surface.

12. The vehicle of claim 6, comprising a pair of horizontal tail surfaces extending between the vertical fins, a first horizontal tail surface being spaced above a second horizontal tail surface in a biplane arrangement, the at least one horizontal tailplane being the second horizontal tail surface, and the rearmost edge section lies in a plane behind the wheels at the lower regions of the fins when in the second position.

13. The vehicle of claim 11, wherein moveable flight control surfaces are provided only on the first horizontal tail surface.

14. The vehicle of claim 1, wherein the rearmost edge section is configured to act as a rear bumper when in the second position when the vehicle is configured for road use.
